(19) United States
(12) Patent Application Publication
(10) Pub. No.: US 2020/0224772 A1
(43) Pub. Date: Jul. 16, 2020

(54) Solenoid Valve with a Pneumatic Cylinder

(71) Applicant: Guanghua Wu, McKinney, TX (US)

(72) Inventor: Guanghua Wu, McKinney, TX (US)

(21) Appl. No.: 16/501,480

(22) Filed: Dec. 8, 2018

(51) Int. Cl. F16K 1/30; F15B 11/072; F16K 31/06

(52) U.S. Cl. CPC F16K 1/307; F16K 31/0658; F15B 11/072

(57) ABSTRACT

A valve apparatus has both solenoid and pneumatic drivers. Solenoid controls the flow rate, and pneumatic driver will provide a seal force to realize near zero sealing wherever needed. Pneumatic driver uses welded diaphragm cylinder structure so the whole system is small enough to fit into the case of a mass flow controller. The valve apparatus uses a diaphragm structure and the diaphragm is directly over the valve seat, so all other valve components will not expose to process gases. The valve apparatus is equipped with means to adjust air gap and preload force. A spacing spring is used to keep the centering of the plunger to avoid the friction between plunger and bearing as the conventional solenoid valves have. The solenoid driver can work alone with pneumatic driver removed wherever there is no close to zero sealing needed.

### FIELD OF THE INVENTION

The present invention is related to solenoid valves used in mass flow controllers (MFC), more specifically in the semiconductor industry.

### BACKGROUND OF THE INVENTION

MFC are used to deliver process gases for semiconductor processes. The MFCs are required to be accurate (less than 1% of full flow rate), fast response (less than 100 millisecond or faster), small footprint (about 1.125″ wide and 4.132″ long), corrosion resistant and ultra clean. The valves used in the MFCs have much to do with the requirements. Solenoid valves can satisfy most of the requirements with a relatively low cost. As a nature of solenoid valves, they cannot seal the valve absolutely, the leak-by rate can be controlled to the level of less than 1% of full flow, satisfying most of applications, but some semiconductor processes require the leak-by to be less than 0.005% of full flow. Different measures have been used to meet the requirement, such as improving the surface conditions (flatness and finishing) of the valve components, screening valve components, etc. These measures are expensive, and they are almost reached the limitation of the manufacturing equipment. Changing the material of valve components from metals to polymers, such as Polychlorotrifluoroethylene (PCTFE) will improve the sealing (may still not enough), but it will reduce the liability of the valves and increasing the cost. To reach a close to zero seal, other than the surface condition, the sealing pressure is also a key parameter. The sealing force for most of pneumatic isolation valves is usually at a level of 100 to 200 pounds. Due to the space and power limitation, the total force of the solenoids used in MFC usually is less than 15 pounds and the force used in sealing is mostly less than 0.5 pound for the reason of design and performance. Pneumatic Isolation valves are usually driven by air cylinders, although they can provide larger sealing force, but they cannot stop precisely at certain position to obtain certain flow rate, so they cannot be used to control the flow rate of MFC. It is the intension of this invention to solve the sealing issue and at the same time improve the design of solenoid valve.

### SUMMARY OF THE INVENTION

In this disclosure, a pneumatic cylinder is mounted on the top of a solenoid valve, this makes the valve can control the flow rate with its solenoid valve and reach to close to zero sealing with the pneumatic cylinder. The pneumatic cylinder is removable, and the solenoid valve can work alone when the requirement of leak-by is not very strict. A diaphragm covers valve seat directly, so no other valve components will be exposed to flow medium. The air gap and valve preload are adjustable. The pneumatic cylinder is welded diaphragm structure to make it small. This makes the solenoid valve and the pneumatic cylinder can be fitted into a 1.125″ wide mass flow controller.

### BRIEF DESCRIPTION OF THE DRAWINGS

FIG. 1 is a section view of one embodiment of this invention.

FIG. 2 is a detail view of FIG. 1 at valve seat area.

FIG. 3 is a perspective view of plunger assembly.

FIG. 4 is a perspective view of spacing spring.

FIG. 5 is a perspective view of spring cap.

FIG. 6 is a perspective view of whole valve system.

FIG. 7 is a section view of another embodiment of this invention.

FIG. 8 is a perspective view of chart of valve force balance.

FIG. 9 is a perspective view of a lock nut.

FIGS. 10A and 10B are section views of normal flow direction valve and reverse direction flow valve, respectively.

### DETAILED DESCRIPTION OF THE INVENTION

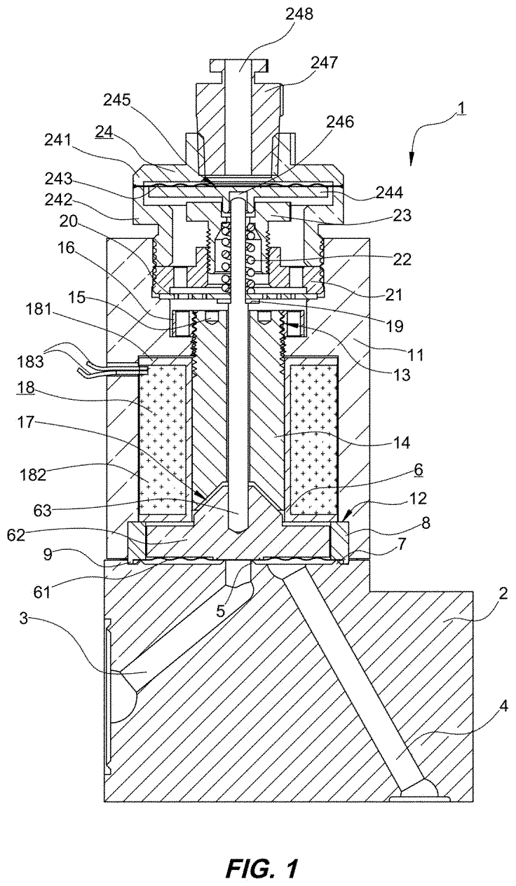

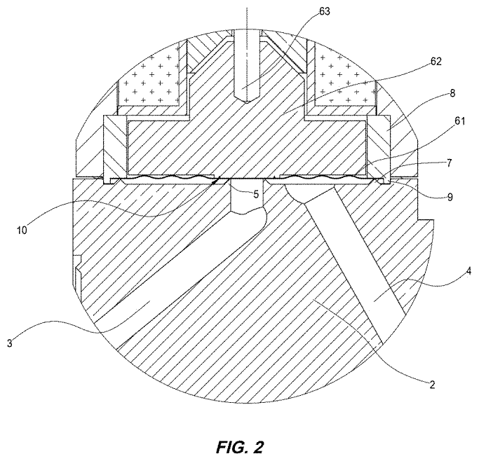

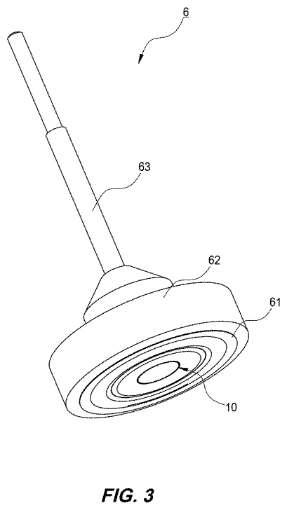

FIG. 1 is a section view of one of the embodiments of this invention and FIG. 2 is an enlarged view of the valve seat area. The valve apparatus 1 of this invention is detachably mounted to a valve block 2, which is preferably made of 316L VIM/VAR or 316L. On the valve block 2, inlet port 3 and outlet port 4 are formed. The valve seat 5 and sealing edge 7 are also formed on the valve block 2 (FIG. 2). The center part of diaphragm 61 is covering the valve seat 5. The periphery of diaphragm is air-tightly clamped between sealing edge 7 and a press ring 8. The valve seat 5 and sealing edge 7 share same plane with the top surface of valve block 2. This will simplify the manufacturing, only one grounding or lapping operation for the valve block top plane is needed, and keep the sealing edge, valve seat, and solenoid components in a good alignment. Diaphragm assembly 6 (FIGS. 2 and 3) consists of diaphragm 61, plunger 62, and plunger shaft 63. Diaphragm 61 is preferably made of Inconel 718 or similar metal, to take advantage of its high strength and corrosion resistance, because it needs to endure high level of fatigue stress and corrosive environment. It is waved by stamping to obtain a larger linear stroke. It is welded to plunger 62 by laser or EB welding (10). The welding can be all around or spotted to 6, 8 or more points. The plunger 62, which is made of magnetic metal, preferable 4xx series stainless steel, has an 90° angled top. A plunger shaft 63, made of non-magnetic metal, 3xx series stainless steel or equivalent is press-fitted into the center bore of the plunger 62. When the valve 1 is in close status, the diaphragm 61 is pushed toward the valve seat 5 by a combined forces that will be described later, the flow between inlet port 3 and outlet port 4 will be stopped. When diaphragm 61 is lifted by solenoid induction force, the gas will flow from inlet port 3 to outlet port 4 through valve seat 5, the valve will be open. Press ring 8 is made of magnetic metal, preferred to be 4xx series stainless steel. It has a protruded ring 9, which can help to align between solenoid part of valve 1 and valve block 2, at the same time, it keeps diaphragm 61, so as plunger assembly 6 centered with valve seat 5.

Referring to FIG. 1 again, solenoid has a body 11 made of magnetic metal, it can be silicon steel, 1010 steel or equivalent, if it is not magnetic stainless steel, corrosion resistant plating is needed. Body 11 has a step 12, when solenoid valve 1 including body 12 is mounted to valve block 2, step 12 will exert force on press ring 8, which in turn applies pressure on diaphragm 61, seals the valve at the sealing edge 7. Body 11 also has a thread 13 to mate with the thread of upper stem 14, which is made of magnetic metal, such as silicon steel, 1010 steel or equivalent. Upper stem 14 can be rotated by special tool anchored on holes 15, while doing so, the stem 14 will move up and down along the thread 13. Stem 14 has a 90° concave lower end to mate with the angled top end of plunger 62. Lock nut 16 will lock the stem after adjusting. By adjusting the stem 14, air gap 17 will be adjusted. Lock nut 16 also has its adjusting holes (not labeled). Its material is preferably magnetic metal. Coil assembly 18 consists of bobbin 181 made of glass filled Nylon or equivalent, coil 182 winded by copper magnetic wire, lead wires 183, and isolation tape, etc. When coil 18 is energized by letting current flow through magnetic wire, a magnetic loop will be formed through body 11, press ring 8, plunger 61 and stem 14. The tendency is to close the air gap 17, which means to move the plunger upward, flex the diaphragm upward, separate diaphragm 61 from the valve seat 5 and open the valve.

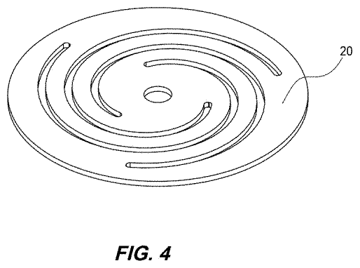

Spring support washer 19 is resting on the shoulder of plunger shaft 63, upon it is a spacing spring 20 (FIG. 4). The periphery of spacing spring 20 is clamped between a recess bore of solenoid body 11 and spacing spring nut 21. Spacing spring 20 can be made of common chrome steel, such as 304 as its stress level is not very high. Its function is to keep plunger assembly 6 centered. Conventionally, this is done by using a bearing surrounding the plunger shaft, but that will increase the friction force, so as to increase hysteresis and slow down the valve.

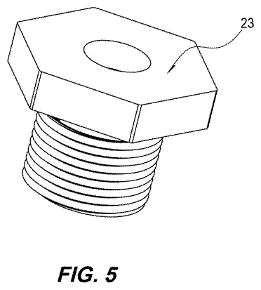

A compression adjust spring 22 is resting on the top of spacing spring 20. It is used to adjust preload force between diaphragm 61 and valve seat 5 to obtain certain leak-by flow rate. When there is no pneumatic cylinder in use, as in another embodiment described later, adjust spring 22 will be fully responsible to obtain required leak-by flow rate. The combination of diaphragm 61, spacing spring 20 and adjust spring 22 consists the elastic response system of the valve assembly 1. The top end of adjust spring 22 is fell into the pocket provided by spring cap 23 (FIG. 5), which is threaded into the through thread of spacing spring nut 21. The hex flange of spring cap 23 is used to adjust the preload of spring 22.

Pneumatic cylinder assembly 24 is threaded into the thread in solenoid body 11, the same thread used by spacer spring nut 21. In this embodiment, pneumatic cylinder 24 is also served as a lock nut for spacer spring nut 21. The main body of pneumatic cylinder 24 consists of two parts, upper body 241 and lower body 242, welded together and sandwiched a waved diaphragm 243. A backup disk 244 is welded (245) to the diaphragm 243. Backup disk 244 is also providing a support for diaphragm 243 to avoid it to be damaged under high pressure. At the bottom center of backup disk 244, there is a bore 246 to host plunger shaft 63. The gap between the bottom of bore 246 and the round end of plunger shaft 63 is around 0.015″, enough for the possible maximum stroke of the solenoid. On the center of the upper cylinder body 241, a fitting 247 is mounted by threading or other means. The driving gas will flow in and out of the cylinder through port 248. The pressure source will be set at a pressure 60 to 80 psig, which will give the cylinder 40 to 50 pounds force to push down the plunger shaft 63 to seal the valve.

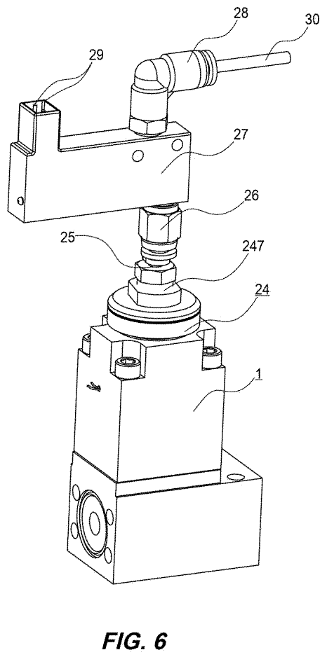

The whole valve system is demonstrated in FIG. 6. A tube 25 is plugged into the port 248 (shown in FIG. 1) of fitting 247 on one end and fitting 26 on the other end. The fitting 26 is mounted to a solenoid valve 27, so is another fitting 28. Tube 30 will be connected to pressure gas source. The solenoid 27 is powered and controlled through connecting pins 29. The power can be supplied from outside source of the mass flow controller (if the circuit of mass flow controller does not have enough power to drive solenoid valve 27 and the valve assembly 1 of this invention), but the control signal is from the control circuit of the mass flow controller to get a seamless control with the valve assembly 1 of this invention. When the valve starts to open from rest (assuming it is a normally close valve), the pneumatic cylinder will be depressurized first, the diaphragm 244 of pneumatic cylinder will return to its natural position by its resilient force of diaphragm 243, and the solenoid 1 will take over immediately. When the valve needs to be closed, the coil of solenoid 1 will deenergized first and the pneumatic cylinder will be pressurized right after immediately to close the valve. Fitting 26, 28, solenoid 27 actually will be placed outside of mass flow controller cover, because there is not enough room inside. They are put on the top of the valve assembly 1 in FIG. 6 is just for the sake of explanation.

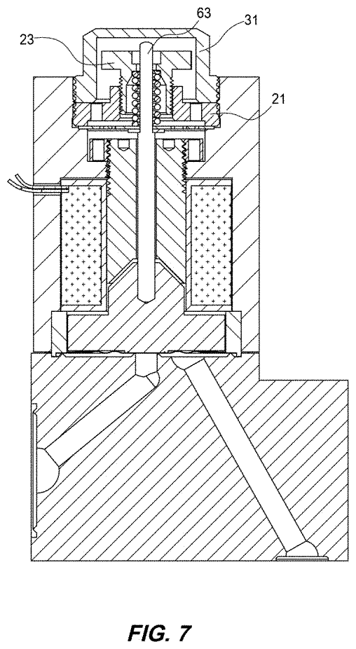

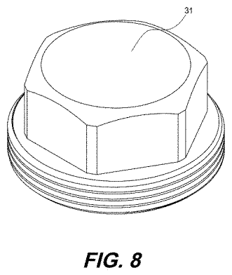

Unless there is a strict requirement for the leak through rate, the solenoid valve 1 of this invention can work alone without the pneumatic cylinder 24. FIG. 7 shows another embodiment of this invention. In the place of pneumatic cylinder 24 as shown in FIG. 1, a lock nut 31 (also see FIG. 8) will lock up the spacing spring nut 21. In this embodiment, both of the lock nut 31 and spring cap 23 have a very good access. The makes it easy to adjust or replace spring 22, if there is a need to increase or decrease the stiffness of the adjust spring 22 for different flow rate bins. It is also possible by change some parts to put a distance sensor on the top of the plunger shaft 63 to measure the valve stroke.

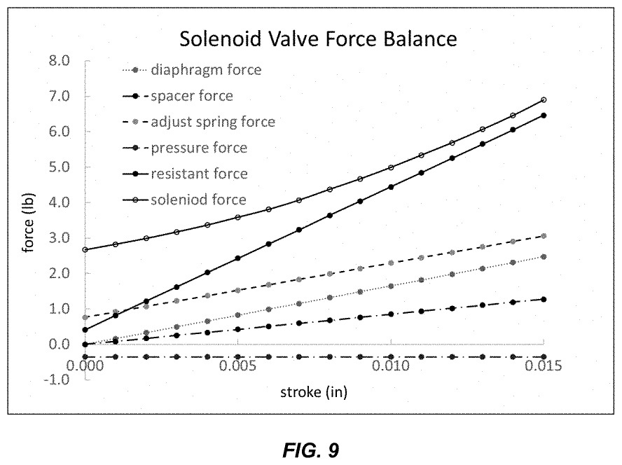

FIG. 9 is a chart showing the valve force balance situation. The curve on the top of the curves is the force what the solenoid can provide at full power. The second curve from the top is the total resistant force that the solenoid needs to overcome to lift the valve. It is a summation of those curves below it, including resilient forces from diaphragm 61, spacing spring 20, adjust spring 22 and pressure force acting on the diaphragm 61 on the inside of valve seat area. It can be seen that the pressure force is negative on the chart, because it is aiding the solenoid to push the diaphragm open.

### ADVANTAGES OF THIS INVENTION

1. Adding a pneumatic cylinder can make the solenoid valve reach close to zero leak-by.

2. Comparing with using a downstream pneumatic isolation valve to realize zero leak, this invention has several benefits:
a) It is faster. The controls of solenoid valve and pneumatic cylinder are synchronized by using the same control system;
b) When using downstream isolation valve to seal the mass flow controller (MFC), after closing the isolation valve, the connecting tube between MFC outlet and the isolation valve will contain some gas, it will flow into the downstream system uncounted when next cycle starts.

3. By using the diaphragm structure in this invention, only diaphragm is contacting process gases. This will reduce the requirements for materials of solenoid and valve. For example, only one magnetic metal, KM 45, is SEMI (Semiconductor Equipment and Materials International) approved, and its availability is scant, and the price is high.

4. As the pneumatic cylinder is making the final sealing, the solenoid valve only needs to be able to seal the valve below the flow rate of turn-down ratio, normally below 2% of full flow rate. It makes huge difference between 2% and less than 1% (worst case below 0.005%). The requirement for the manufacturing of valve components is much lower, so is the cost.

5. Air gap can be adjusted easily in this invention. Air gap adjustment is important to obtain a good performance. Many traditional valves use spacers to adjust the air gap and opening the whole valve to do so is often needed.

6. Valve preload is adjustable by tightening or loosening the adjust spring or replacing the spring.

7. The centering of plunger assembly is relying on a spacing spring, it has less friction, better hysteresis and faster comparing with traditional bearing support.

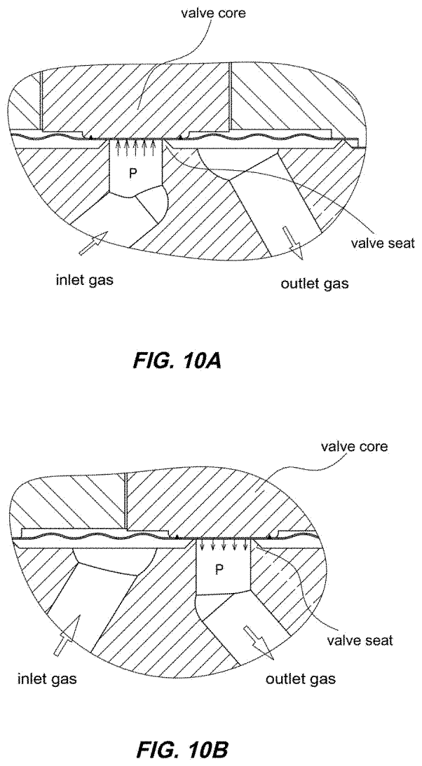

8. As there is very little leak-by concern, the gas flow direction can take normal direction for all bins. Traditionally, due to the gas pressure force, inverse flow direction is often used for higher flow rate bins. This can be explained by FIGS. 10A and 10B. FIG. 10A is a normal flow direction and FIG. 10B is a reverse flow direction. In a normal flow direction, the gas pressure P is pushing the valve open, when the diameter of valve bore is small at low flow rate, the gas pressure force P is ignorable comparing with the preload force. But at larger flow rate, the gas pressure force P is significant. For example, when the valve bore diameter is 0.113″ and gas pressure is 35 psid, the gas pressure force is around 0.35 pounds, this will most likely surpass the preload force which the valve can provided. To get a low leak-by flow rate, most solenoid valves are only using normal direction gas flow at low flow rate and have to use reverse flow direction at high flow. Comparing with normal direction flow, reverse flow has a larger “dead volume” (the volume between flow sensor outlet and valve inlet), large dead volume will slow down valve's response time. Also, for reverse flow, it is harder to open the valve, because the valve needs to overcome the pressure force first. At the instant the valve is open, with the pressure force suddenly reduced, the valve core will over react to cause a over shoot. For this invention, because there is little leak-by concern, normal flow direction will be used for all the flow rates, the response time will be faster.

9. The pneumatic cylinder uses weld diaphragm structure instead of traditionally piston-cylinder structure, make the whole valve small enough to fit in a 1.125″ MFC.

What is claimed is:

1. A valve apparatus comprising:
a valve block with a gas inlet passage and an outlet passage, a valve seat, and a sealing edge;
a solenoid body mounted on said valve block;
a coil located inside of said solenoid body;
a stem located at the top part of a bore of said coil;
a first diaphragm clamped at its periphery on said sealing edge and covering the top of said valve seat;
a press ring pressed by a step of said solenoid body on the said first diaphragm;
a plunger welded to said first diaphragm and located inside the bottom part of said bore of said coil;
a plunger shaft inserted and fixed in the top bore of said plunger and going through the center bore of said stem;
a support washer rested on a step of said plunger shaft;
a spacing spring supported by said support washer and restrain the top part of said plunger shaft radially with its center hole;
a spacing spring nut clamped said spacing spring to said solenoid body by mating its thread with the thread of said solenoid body;
an adjust spring rested on the top of said spacing spring;
a spring cap hosting, centering and adjusting said adjust spring, mounted on said spacing spring nut; and
a loading means of pushing diaphragm toward valve seat and releasing it by energizing and deenergizing said coil.

2. The valve apparatus according to claim 1, wherein said first diaphragm is preformed, covering valve seat directly and isolating other valve components from process gases.

3. The valve apparatus according to claim 1, wherein said first diaphragm is also on the top of said sealing edge, seals the valve apparatus from environment.

4. The valve apparatus according to claim 1, wherein both the top end of said plunger and the bottom end of said stem have 90° ends to mate with each other.

5. The valve apparatus according to claim 1, wherein said plunger shaft transfers the force applied to its top end to said first diaphragm.

6. The valve apparatus according to claim 1, wherein said plunger shaft is kept centered by said spacing spring.

7. The valve apparatus according to claim 1, wherein said adjust spring can put an adjustable pressure on said plunger shaft.

8. The valve apparatus according to claim 1, wherein said loading means refers to controlling distance between said valve seat and said first diaphragm by changing the current of said coil.

9. The valve apparatus of claim 1 comprises a pneumatic cylinder which comprising:
a lower cylinder case mounted on the top of said solenoid body;
a second diaphragm welded to the top surface of said lower cylinder case concentrically and formed a first chamber;
an upper cylinder case welded to the top surface of said second diaphragm concentrically with said lower cylinder case and said second diaphragm and formed a second chamber with said second diaphragm;
a backup plate welded on the bottom side of said second diaphragm with a bore on the bottom side of said backup plate housing and kept a gap from the top end of said plunger shaft of claim 1, and
a loading means to put pressure on said first diaphragm and release it through said plunger shaft by pressurizing and depressurizing said second chamber.

10. The pneumatic cylinder according to claim 9, wherein said second diaphragm is preformed and welded on periphery to said lower cylinder case and said upper cylinder case, will flex downward when said second chamber is pressurized and recovers upward where said second chamber is depressurized.

11. The pneumatic cylinder according to claim 10, the flexion of said second diaphragm will be transferred to said plunger shaft of claim 1 through said backup plate of claim 9.

12. The valve apparatus according to claim 1 can work with or without said pneumatic cylinder of claim 9.
